(19) United States
(12) Patent Application Publication
(10) Pub. No.: US 2013/0280555 A1
(43) Pub. Date: Oct. 24, 2013

(54) MAGNETIC DISK, LUBRICANT-LAYER-FORMING COMPOSITION FOR FORMING A LUBRICANT LAYER, AND METHOD FOR FORMING THE LUBRICANT LAYER

(71) Applicants: Samsung Electro-Mechanics Japan Advanced Technology Co., Ltd., (US); UNIVERSITY OF YAMANASHI, Yamanashi (JP)

(72) Inventors: Yuichiro HARAMOTO, Yamanashi (JP); Mitsuo KODAMA, Shizuoka (JP)

(73) Assignees: Samsung Electro-Mechanics Japan Advanced Technology Co., Ltd., Shizuoka (JP); UNIVERSITY OF YAMANASHI, Yamanashi (JP)

(21) Appl. No.: 13/865,602

(22) Filed: Apr. 18, 2013

(30) Foreign Application Priority Data
Apr. 20, 2012 (JP) 2012-096231

(51) Int. Cl. G11B 5/725; G11B 5/84

(52) U.S. Cl. CPC G11B 5/725; G11B 5/8408
USPC 428/800; 427/127; 546/347

(57) ABSTRACT

A magnetic disk according to one embodiment of the present invention includes a base material and a lubricant layer provided on or over a base material. The lubricant layer contains a rod-like ionic liquid crystal compound having a cation group and an anion group.

### BACKGROUND OF THE INVENTION

1. Field of the Invention

The present invention relates to a magnetic disk, a lubricant-layer-forming composition for forming a lubricant layer on the magnetic disk, and a method for forming the lubricant layer.

2. Description of the Related Art

In recent years, as they become smaller in size and larger in capacity, disk drive devices, such as hard disk drives, have been making their way into a great variety of electronics. A disk drive device has a magnetic disk and a magnetic head slider (hereinafter referred to simply as “head” as appropriate). Formed on the magnetic disk are a number of concentric recording/reproducing tracks. When the disk drive device is operating, the head is held opposite to the surface of the magnetic disk being rotated by a rotation drive mechanism with a slight gap (hereinafter referred to as “head lift” as appropriate) between them. And the head is controlled to trace the tracks in such a manner as to record data on the magnetic disk and read the data recorded thereon.

One of these disk drive devices proposed has a lubricant layer on the surface of the magnetic disk, such as disclosed in Japanese Unexamined Patent Application Publication No. 2004-62956, for example. The magnetic disk disclosed in this publication has a lubricant layer containing a discotic liquid crystal compound on its surface. This feature works to reduce the vibration of the head and improve the running stability and continuous sliding durability.

Over the years, there have constantly been demands on the disk drive devices as described above for larger capacities. One of the conceivable methods to realize larger capacities for disk drive devices is the increase in their recording density. The recording density of a magnetic disk can be increased by reducing the head lift. Yet, when the head lift is reduced, there are greater possibilities of the head touching (colliding with) the surface of the magnetic disk. And there are greater possibilities of the lubricant layer getting peeled from the surface of the magnetic disk as a result of collisions of the head. Notably, an increasing number of disk drive devices are today being incorporated into mobile electronic devices such as notebook-size personal computers and mobile music reproduction devices.

Notably, an increasing number of disk drive devices are today being incorporated into mobile electronic devices, such as notebook-size personal computers and mobile music reproduction devices. And the disk drive devices placed in these mobile electronics can often be subjected to shocks resulting from drops and such other movements of the electronic devices. They are thus prone to far greater likelihood of the lubricant layers peeling from the collision between the magnetic disk and the head.

The peeling of the lubricant layer from the surface of the magnetic disk can cause irregular running of the head in an area where the peeling of the lubricant layer exists. This can hinder the normal operation of data writing or reading. Under these circumstances, the inventors have come to recognize that the conventional magnetic disks still have room for improvement toward making the capacity of the disk drive devices larger while retaining their operation reliability.

### SUMMARY OF THE INVENTION

The present invention has been made under the foregoing circumstances, and a purpose thereof is to provide a technology for making the capacity of the disk drive devices larger while retaining their operation reliability.

One embodiment of the present invention relates to a magnetic disk. The magnetic disk includes: a base material; and a lubricant layer provided on or over a base material, the lubricant layer containing a rod-like ionic liquid crystal compound having a cation group and an anion group.

Another embodiment of the present invention relates to a lubricant-layer-forming composition. The lubricant-layer-forming composition is a lubricant-layer-forming composition for forming a lubricant layer provided on or over a base material of a magnetic disk, and the lubricant-layer-forming composition contains a rod-like ionic liquid crystal compound having a cation group and an anion group.

Still another embodiment of the present invention relates to a method for forming a lubricant layer. The method for forming the lubricant layer includes: applying the lubricant-layer-forming composition according to the above-described embodiment to the base material of the magnetic disk; and heating the lubricant-layer-forming composition applied to the base material.

Optional combinations of the aforementioned constituting elements, and implementations of the invention in the form of methods, apparatuses, systems, and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a plane view showing a general structure of a disk drive device having a magnetic disk according to a embodiment;

FIG. 2 is a schematic cross-sectional view of a magnetic disk, according to an embodiment, taken along the line A-A of FIG. 1;

FIG. 3 is an enlarged schematic illustration of a part of a lubricant layer; and

FIG. 4 is an enlarged schematic illustration of a part of a lubricant layer having a structure of stacked rod-like ionic liquid crystal compounds

### DETAILED DESCRIPTION OF THE INVENTION

The invention will now be described by reference to the preferred embodiments. This does not intend to limit the scope of the present invention, but to exemplify the invention.

Hereinafter, the present invention will be described based on preferred embodiments with reference to the accompanying drawings. The same or equivalent constituents or members illustrated in each drawing will be denoted with the same reference numerals, and the repeated description thereof will be omitted as appropriate. The dimensions of the members in each drawing are illustrated by appropriately scaling the actual sizes thereof for ease of understanding. Some of the components and members in each Figure may be omitted if they are not important in the course of explanation. The preferred embodiments do not intend to limit the scope of the invention but exemplify the invention. All of the features and the combinations thereof described in the embodiments are not necessarily essential to the invention.

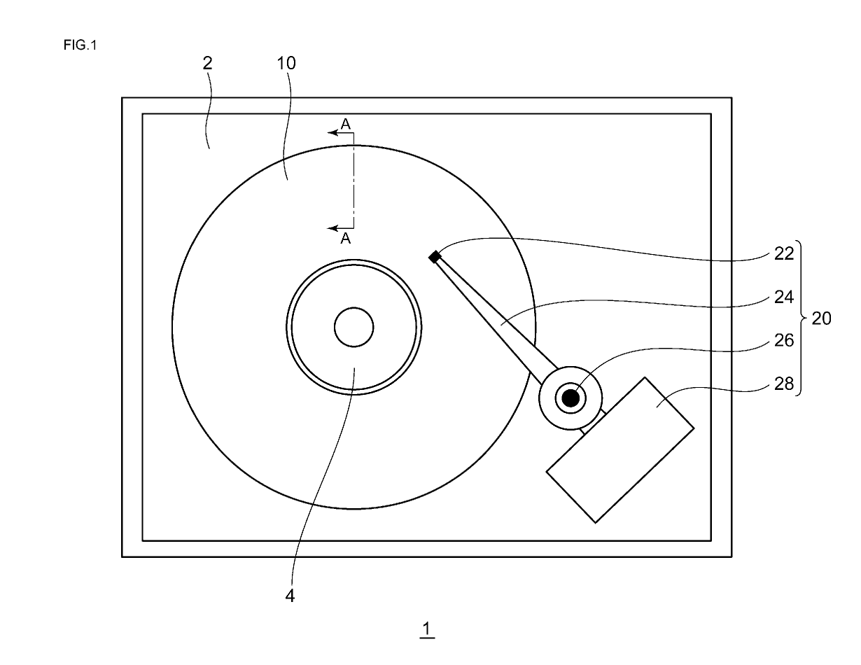

FIG. 1 is a plane view showing a general structure of a disk drive device having a magnetic disk according to an embodiment. To show an internal structure of the disk drive device, a top cover is removed in FIG. 1. A disk drive device 1 includes a base 2, a hub 4, a magnetic disk 10, a data read/write unit 20, and a top cover (not shown). In the following description, a top side where the magnetic disk 10 is mounted relative to the base 2 is defined as “upside”.

The base 2 is a component formed such that, for example, an aluminum alloy is molded using a die-cast. The hub 4 is rotatably mounted to the base 2 via a bearing unit (not shown). The hub 4 is rotated and driven by a brushless motor (not shown). The magnetic disk 10, which is placed and held on the hub 4, rotates together with the rotation of the hub 4. A detailed description of the magnetic disk 10 will be given later.

The data read/write unit 20 includes a head 22, a swing arm 24, a pivot assembly 26, and a voice coil motor 28.

The head 22, mounted on a tip of the swing arm 24, records data to and reads data from the magnetic disk 10. The pivot assembly 26 swingably supports the swing arm 24. The swinging of the swing arm 24 displaces the head 22 relative to the base 2 and the magnetic disk 10. The voice coil motor 28 causes the swing arm 24 to swing about the pivot assembly 26 and thereby moves the head 22 to a desired position on the magnetic disk 10. The pivot assembly 26 and the voice coil motor 28 may be configured by the use of any known technique for controlling the position of the head 22. The top cover is secured to the base 2 by not-shown fasteners such as screws.

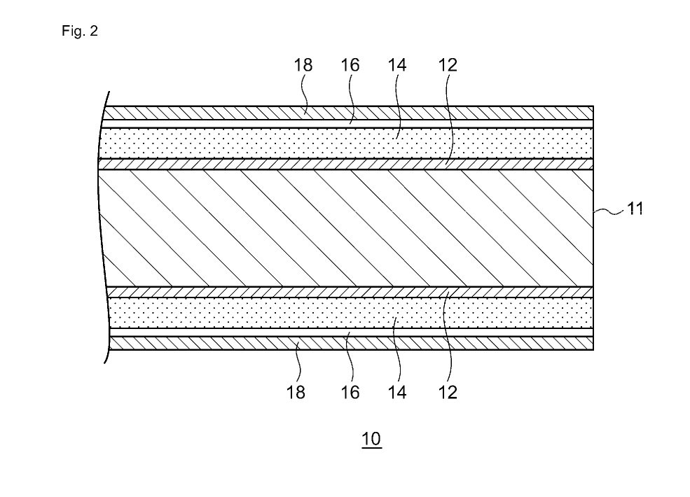

A description is now given of a structure of the magnetic disk 10. FIG. 2 is a schematic cross-sectional view of a magnetic disk, according to an embodiment, taken along the line A-A of FIG. 1. The magnetic disk 10 is comprised of a base material 11, ground layers 12, magnetic layers 14, protective layers 16, and lubricant layers 18. In the present embodiment, the ground layer 12 is formed on the surface of the base material 11, the magnetic layer 14 is formed on the surface of the ground layer 12, the protective layer 16 is formed on the surface of the magnetic layer 14, and the lubricant layer 18 is formed on the surface of the protective layer 16.

The base material 11, which is constructed of a non-magnetic material, may be formed of a metal such as aluminum, or an inorganic material such as glass. The ground layer 12 has a function of having the magnetic layer 14 adhered to the base material 11. In the present embodiment, the ground layer 12 made of a Cr alloy is formed on the surface of the base material 11 made of glass. The magnetic layer 14 is a layer where information is recorded. A material that constitutes the magnetic layer 14 may be selected as appropriate to obtain a desired recording density. In the present embodiment, the magnetic layer 14 is formed such that a magnetic material composed mainly of Co—Cr—Ta—Pt is adhered to the surface of the ground layer 12 by a sputtering method.

The protective layer 16 is a layer used to protect the surface of the magnetic layer 14 against the head 22. The protective layer 16 may be formed such that a material composed mainly of carbon, for example, is applied by a sputtering method or an ion beam deposition (IBD) method. Where the sputtering method is used, the method is preferably employed in an atmosphere of an argon or nitrogen gas for the purpose of improving the hardness of the protective layer 16. The lubricant layers 18 constitute the outermost layers of the magnetic disk 10. Provision of the lubricant layers 18 enable the head 22 to slip or slide on the surface of the magnetic disk 10 with the head 22 in contact with the magnetic disk 10, thereby preventing the surfaces of the head 22 and the magnetic disk 10 from being crashed or destroyed.

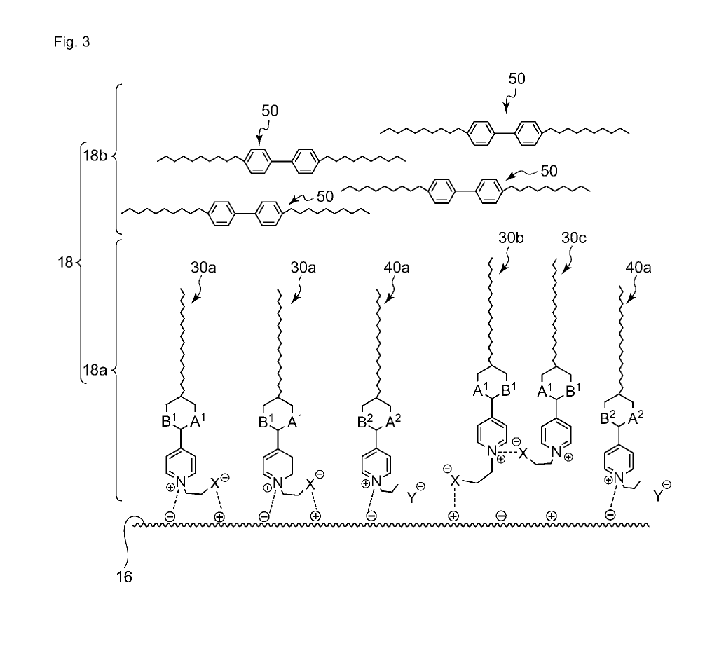

A detailed description is now given of a structure of the lubricant layer 18. FIG. 3 is an enlarged schematic illustration of a part of a lubricant layer. FIG. 3 shows an exemplary state where a first pyridinium salt type liquid crystal compound and a second pyridinium salt type liquid crystal compound described later are mixed.

The lubricant layer 18 contains a rod-like ionic liquid crystal compound having a cation group and an anion group. The cation group in the rod-like ionic liquid crystal compound is preferably a pyridinium group. That is, the rod-like ionic liquid crystal compound is preferably a pyridinium salt type liquid crystal compound. Such a pyridinium salt type liquid crystal compound may be the first pyridinium salt type liquid crystal compound represented by the following formula (1) and the second pyridinium salt type liquid crystal compound represented by the following formula (2), for instance.

[symbol]

[In the formulas (1), R¹ is an alkyl group, an alkoxy group, or a group having an unsaturated bond represented by the following formula (3). A¹ and B¹ are each independently O, S, NH or CH₂. X⁻ is SO₃⁻, COO⁻, PO₃⁻, or PO₃²⁻. “n” is an integer greater than or equal to “0”.]

[symbol]

[In the formulas (2), R² and R³ are each independently an alkyl group, an alkoxy group, or a group having an unsaturated bond represented by the following formula (3). A² and B² are each independently O, S, NH or CH₂. Y⁻ is a halogen atom.]

[symbol]

[In the formulas (3), R⁴ is H or CH₃, and Z is (CH₂)ₘ, (CH₂)ₘ—O, CO—O—(CH₂)ₘ, CO—O—(CH₂)ₘ—O, C₆H₄—CH₂—O, or CO. “m” is any one of integers 1 to 30.]

In the formula (1), the alkyl group of R¹ is a straight-chain or branched-chain alkyl group. A carbon number of alkyl group may preferably be 3 to 24, more preferably 5 to 22, and most preferably 8 to 18. Setting the carbon number of alkyl to 3 or greater can achieve the lubrication effect of the lubricant layer 18 more reliably. Also, setting the carbon number of alkyl to less than or equal to 24 enables the rod-like ionic liquid crystal compound contained in the lubricant layer 18 to be less likely to be crystallized. An example of the alkyl group of R¹ may be a methyl group, ethyl group, butyl group, pentyl group, hexyl group, octyl group, dodecyl group, pentadecyl group, octadecyl group, or the like.

The alkoxy group R¹ is a straight-chain or branched-chain alkoxy group. This alkoxy group may preferably be an alkoxy group represented by C_{q}H(2_{q}+1)O—where q is preferably 1 to 30 and more preferably 7 to 22.

In the above formula (1), n may preferably be any one of 1 to 20, more preferably any one of 1 to 5, and most preferably 3 or 4. Setting n to be 1 or greater enables the cation group (X⁻) of the first pyridinium salt type liquid crystal compound to be more likely to be bonded to a positive ion portion on the surface of an underlying layer (the protective layer 16 in the present embodiment) of the lubricant layer 18. Also, setting n to be less than or equal to 20 suppresses a steric hindrance caused by an alkyl chain and enables a positive ion portion (N⁺) of the first pyridinium salt type liquid crystal compound to be more likely to form an ionic bond with a negative ion portion in the surface of the underlying layer of the lubricant layer 18.

In the second pyridinium salt type liquid crystal compound expressed by the above formula (2), the alkyl group R² is a straight-chain or branched-chain alkyl group and the carbon number may preferably be 3 to 24, more preferably 5 to 22, and most preferably 8 to 18, similarly to R² of the formula (1). The preferably range of the carbon numbers may be determined in view of achieving the lubrication effect of the lubricant layer 18 and in view of suppressing the crystallization of the rod-like ionic liquid crystal compound. An example of the alkyl group of R² may be similar to that of R².

The alkyl group R³ is a straight-chain or branched-chain alkyl group, and the carbon number may preferably be 0 to 20 and more preferably 0 to 3. Setting the carbon number to be less than or equal to 20 suppresses the steric hindrance caused by an alkyl chain and enables a positive ion portion (N⁺) of the second pyridinium salt type liquid crystal compound to be more likely to form an ionic bond with the negative ion portion in the surface of the underlying layer of the lubricant layer 18.

The alkoxy groups R² and R³ are each a straight-chain or branched-chain alkoxy group, similarly to R² of the formula (1) and may preferably be an alkoxy group represented by C_{q}H(2_{q}+1)O—. The q in the alkoxy group R² is preferably 1 to 30 and more preferably 7 to 22. The q in the alkoxy group R³ is preferably 0 to 20 and more preferably 0 to 3.

The entire lengths of the first pyridinium salt type liquid crystal compound and the second pyridinium salt type liquid crystal compound may be adjusted by adjusting the lengths of R² and R², respectively. For example, the sizes of these pyridinium salt type liquid crystal compounds may be such that the length of their liquid crystal portions, namely those including two ring structures, is about 1 nm and the lengths of R¹ and R² are about 1 to 2 nm. Thus the total length will be about 2 to 3 nm, for instance.

The rod-like ionic liquid crystal compound constituting the lubricant layer 18 has a cation group and an anion group at the terminals as described above. On the other hand, as shown in FIG. 3, the surface of the protective layer 16 has a positive ion portion and a negative ion portion due to the bias of charge. As a result, the cation group of the rod-like ionic liquid crystal compound forms an ionic bond with the negative ion portion of the protective layer 16, or the anion group of the rod-like ionic liquid crystal compound forms an ionic bond with the positive ion portion thereof. For example, with the first pyridinium salt type liquid crystal compound 30a, the cation group thereof forms an ionic bond with the negative ion portion of the protective layer 16, and the anion group thereof forms an ionic bond with the positive ion portion of the protective layer 16. Also, with the second pyridinium salt type liquid crystal compound 40a, the cation group thereof forms an ionic bond with the negative ion portion of the protective layer 16.

The first pyridinium salt type liquid crystal compound and the second pyridinium salt type liquid crystal compound can exist not only in a bond with the surface of the protective layer 16, but also in an ionic bond with the cation group or the anion group of the rod-like ionic liquid crystal compound bound to the surface of the protective layer 16. For example, with the first pyridinium salt type liquid crystal compound 30b, the anion group thereof forms an ionic bond with the positive ion portion of the protective layer 16, and the cation group thereof forms an ionic bond with the anion group of the first pyridinium salt type liquid crystal compound 30c. The first pyridinium salt type liquid crystal compound 30c is bonded to the protective layer 16 via the first pyridinium salt type liquid crystal compound 30b. It is to be noted that the lubricant layer 18 is not limited to a mixture of the first pyridinium salt type liquid crystal compound and the second pyridinium salt type liquid crystal compound. The lubricant layer 18 may serve the objective of the present invention if it contains at least one of the first pyridinium salt type liquid crystal compound and the second pyridinium salt type liquid crystal compound.

Thus, the rod-like ionic liquid crystal compound is firmly bound in an ionic bond with the surface of the protective layer 16 directly or through another rod-like ionic liquid crystal compound, thereby forming a regularly vertical sequence in relation to the surface of the protective layer 16. That is, the lubricant layer 18 has a film of a smectic liquid crystal phase of the rod-like ionic liquid crystal compound in a uniformly vertical sequence. With the lubricant layer 18 having this film, the magnetic disk 10 can be reliably protected against the contact or collision of the head 22. Also, this film works to reduce the friction coefficient of the lubricant layer 18, thereby lessening the risk of damage to the magnetic disk 10.

In the lubricant layer 18, the terminal portions of the rod-like ionic liquid crystal compound are in an ionic bond with the surface of the protective layer 16. Hence, the rod-like ionic liquid crystal compound seldom separates from the surface of the protective layer 16 and is least likely to disappear through evaporation. Accordingly, the lubricant layer 18 does not easily get peeled or sustain damage even when the head 22 collides with the surface of the magnetic disk 10. As a result, there will be reduced likelihood of any hindrance to the normal operation of data recording and reading by the disk drive device 1. Therefore, larger capacities for the disk drive device 1 can be realized while assuring its operation reliability.

Preferably, the lubricant layer 18 has a monomolecular layer 18a of the rod-like ionic liquid crystal compound in at least a part of the region where it is in contact with the underlying layer (protective layer 16). More preferably, the lubricant layer 18 is the monomolecular layer 18a in its entirety. The lubricant layer 18, if it is comprised of a monomolecular layer 18a of the rod-like ionic liquid crystal compound, can be made thinner in its layer thickness. When the lubricant layer 18 is comprised of a monomolecular layer 18a, the layer thickness of the lubricant layer 18 can be approximately equal to the length of the rod-like ionic liquid crystal compound, namely, about 2 to 3 nm, for example. Note that the layer thickness of the lubricant layer 18 can be measured with an ellipsometer. The monomolecular layer 18a can be formed by adjusting the content of the rod-like ionic liquid crystal compound in the lubricant-layer-forming composition for forming the lubricant layer 18.

Also, preferably, the lubricant layer 18 contains at least one of a non-ionic liquid crystal compound and a non-ionic lubricant. As the non-ionic liquid crystal compound, a non-ionic liquid crystal compound generally known in the art, such as those represented by the following formulas (4) to (13), may be used.

[symbol]

[In the formulas (4) to (13), R⁵ and R⁶ are each independently a straight-chain or branched-chain alkyl group.]

Also, as the non-ionic lubricant, a generally known lubricant, such as an ether-, ester-, or olefin-based lubricant, may be used.

The rod-like ionic liquid crystal compound has a higher affinity for the surface of the protective layer 16 with a bias of charge than the non-ionic liquid crystal compound or lubricant. Accordingly, when the lubricant layer 18 contains a non-ionic liquid crystal compound or lubricant in addition to the rod-like ionic liquid crystal compound, the rod-like ionic liquid crystal compound, as shown in FIG. 3, will move toward the protective layer 16, thus forming a monomolecular layer 18a in the interfacial region facing the protective layer 16. And the non-ionic liquid crystal compound or lubricant will form a non-ionic compound layer 18b above the monomolecular layer 18a. The non-ionic compound layer 18b is effective in preventing moisture from entering the magnetic disk 10 from the surface thereof. This allows the rod-like ionic liquid crystal compound to be bound more firmly to the surface of the protective layer 16. The lubricant layer 18 according to the present embodiment is such that it contains a non-ionic liquid crystal compound 50 of a biphenyl structure (R⁵ and R⁶ being an alkyl group of carbon number 10) as represented by the above formula (4) as the non-ionic liquid crystal compound, and the non-ionic compound layer 18b is formed by the non-ionic liquid crystal compound 50. It should be noted here that one or both of the non-ionic liquid crystal compound and the non-ionic lubricant may be used. Also, one type only for each of them may be used, or a combination of two types or more for each of them may be used.

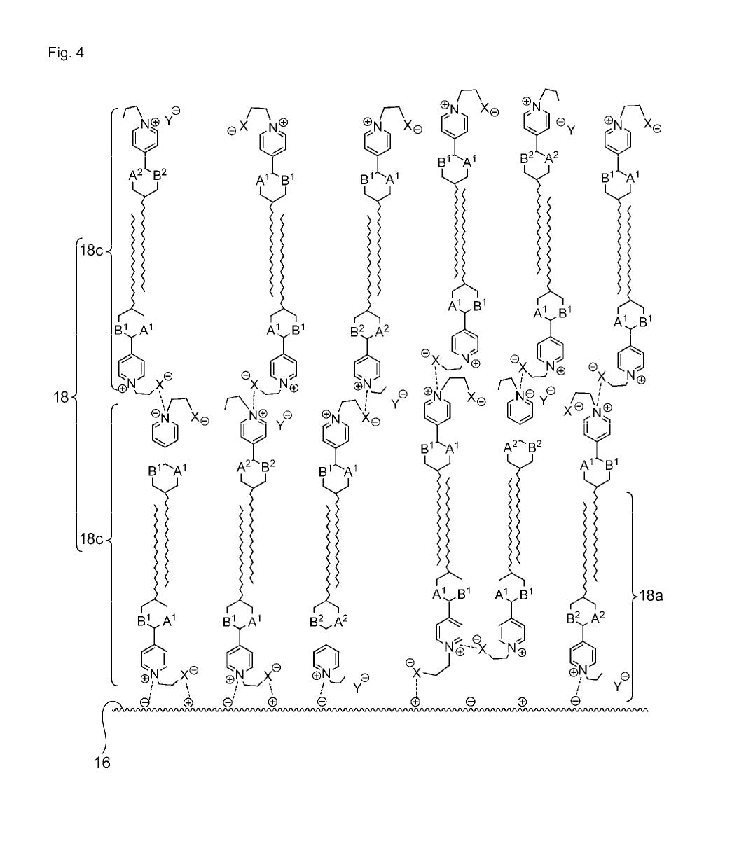

When the content of the rod-like ionic liquid crystal compound in the lubricant-layer-forming composition exceeds the content needed to form the monomolecular layer 18a, the lubricant layer 18 will assume a structure in which the rod-like ionic liquid crystal compounds are stacked as shown in FIG. 4. FIG. 4 is an enlarged schematic illustration of a part of a lubricant layer having a structure of stacked rod-like ionic liquid crystal compounds.

That is, a part of the rod-like ionic liquid crystal compound contained in the lubricant layer 18 is adsorbed to the rod-like ionic liquid crystal compound forming the monomolecular layer 18a as the R² portion in the above formula (1) or the R² portion in the above formula (2) having a hydrocarbon chain gets close to the R² portion or the R² portion of the rod-like ionic liquid crystal compound forming the monomolecular layer 18a through a hydrophobic interaction or the like.

As a result, a double layer 18c of rod-like ionic liquid crystal compounds is formed. In the double layer 18c, the rod-like ionic liquid crystal compound of a first layer and the rod-like ionic liquid crystal compound of a second layer are sequenced in such a manner that the end portions having a cation group or an anion group face outward, respectively. Therefore, another double layer 18c can be stacked on the surface of the double layer 18c bound to the surface of the protective layer 16 if an ionic bond of the cation group and/or the anion group of the other double layer 18c is established. In other words, a plurality of double layers 18c are repetitively stacked on top of each other, depending on the contained amount of the rod-like ionic liquid crystal compound in the lubricant-layer-forming composition. The layer thickness of the lubricant layer 18 can be adjusted by selecting the number of double layers 18c stacked. FIG. 4 shows a lubricant layer 18 having a structure of two stacked double layers 18c as an example. It is to be noted that if the lubricant layer 18 contains a non-ionic liquid crystal compound or a non-ionic lubricant, a non-ionic compound layer 18b (see FIG. 3) will be formed on top of the stacked structure of the double layers 18c.

The rod-like ionic liquid crystal compound constituting the lubricant layer 18 takes a crystal (solid) state or a smectic liquid crystal state at normal temperature. It should be noted that the rod-like ionic liquid crystal compound, when it takes a smectic liquid crystal state at normal temperature, exists in a glassy state in the lubricant layer 18. And when the head 22 touches the surface of the magnetic disk 10 with the operation of the disk drive device 1, the rod-like ionic liquid crystal compound undergoes a phase transition from the crystal state to the smectic liquid crystal state due to the friction heat, or makes a transition from a glassy state to the smectic liquid crystal state. Also, it is to be noted that the rod-like ionic liquid crystal compound can make a phase transition from a smectic liquid crystal state to a liquid state due to the frictional heat. It is considered that rod-like ionic liquid crystal compound in a liquid state exerts high meniscus force, thereby improving the running stability of the head 22.

The phase transition temperature of the rod-like ionic liquid crystal compound constituting the lubricant layer 18 varies with the structure thereof. For example, for the second pyridinium salt type liquid crystal compound of which A² and B² are O, R³ is C₂H₅, and Y is Br in the above formula (2), the phase transition temperature from the crystal phase to the smectic A liquid crystal phase is 35° C., and the phase transition temperature in the reverse direction −25° C., when R² is C₇H₁₅. Also, when R² is C₁₀H₂₁, the phase transition temperature from the crystal phase to the smectic A liquid crystal phase is 60° C., the phase transition temperature in the reverse direction is −25° C., and the phase transition temperature from the smectic A liquid crystal phase to the isotropic liquid phase and that in the reverse direction are both 139° C. Also, when R² is C₉H₁₉, the phase transition temperature from the crystal phase to the smectic A liquid crystal phase is 77° C., the phase transition temperature in the reverse direction is −1° C., and the phase transition temperature from the smectic A liquid crystal phase to the isotropic liquid phase and that in the reverse direction are both 100° C. Also, when R² is C₁₁H₂₃, the phase transition temperature from the crystal phase to the smectic A liquid crystal phase is 88° C., the phase transition temperature in the reverse direction is −18° C., and the phase transition temperature from the smectic A liquid crystal phase to the isotropic liquid phase and that in the reverse direction are both 180° C.

The lubricant layer 18 may contain only one type of rod-like ionic liquid crystal compound. However, from the viewpoint of easier adjustment of the phase transition temperature of the lubricant layer 18, it is preferable that the lubricant layer 18 contains plural types of rod-like ionic liquid crystal compounds. The lubricant layer 18 containing plural types of rod-like ionic liquid crystal compounds can have a greater degree of freedom in adjusting the phase transition temperature thereof than the lubricant layer 18 containing only one type of rod-like ionic liquid crystal compound. It is to be noted here that the aforementioned case of the lubricant layer 18 containing plural types of rod-like ionic liquid crystal compounds includes the following cases. That is, the aforementioned case includes a case where one type each of the first pyridinium salt type liquid crystal compound and the second pyridinium salt type liquid crystal compound are contained, a case where plural types of one of them only are contained, a case where plural types of one of them and one type of the other are contained, and a case where plural types of both of them are contained. The temperature range in which the lubricant layer 18 takes a liquid state can be widened by mixing plural types of rod-like ionic liquid crystal compounds into the lubricant-layer-forming composition and adjusting the compounding ratio as appropriate. As a result, the temperature range in which the magnetic disk 10 can be used in optimal conditions can be widened. For example, the lubricant layer 18 is designed such that the phase transition temperature from the smectic liquid crystal state to the liquid state is in the neighborhood of 100° C.

### Method for Preparation of Lubricant-Layer-Forming Composition

### Synthesis of First Pyridinium Salt Type Liquid Crystal Compound

The first pyridinium salt type liquid crystal compound as represented by the above formula (1) can be synthesized, for example, by causing a reaction between the compound represented by the formula (15) below and the compound represented by the formula (16) below in a solvent according to the reaction formula (14) below.

[symbol]

[R¹, A¹, B¹, X, and n in the reaction formula (14) are synonymous with those in the above formula (1). X¹ represents SO₂, CO, or P(O) (OH).]

In the reaction of the reaction formula (14), the compound represented by the formula (15) and the compound represented by the formula (16) are introduced into a solvent, such as acetonitrile, at a molar ratio of the latter to the former of 0.90 to 1.10, or more preferably 0.95 to 1.05. And the first pyridinium salt type liquid crystal compound can be synthesized through a reaction in an inert atmosphere, such as nitrogen, at 10 to 100° C., or more preferably at 50 to 90° C., for 1 to 60 hours, or more preferably for 10 to 50 hours.

The compound represented by the above formula (15), which is one of the starting materials, is a known compound. For example, a compound for which A¹ and B¹ in the formula (15) are an oxygen atom or a sulfur atom can be manufactured according to a reaction scheme (1) below. That is, a malonic acid ester (17) and a halide (R¹X′) are first reacted with each other to obtain an R¹-introduced malonate (18). Then the R¹-introduced malonate (18) is resolved with LiAlH₄ into a compound (19a) (R¹-introduced 1, 3-pronanediol). Also, if necessary, the reactions are continued to synthesize a compound (19b) through a compound (20) from the compound (19a). Or alternatively a compound (19c) is synthesized through a compound (21) from the compound (19a). Following this, the thus obtained compound (19a), compound (19b), or compound (19c) is reacted with pyridine-4-aldehide (22) to obtain a compound (15) (see Japanese Unexamined Patent Application Publication No. Hei10-53585, Japanese Unexamined Patent Application Publication No. Hei10-338691, Japanese Unexamined Patent Application Publication No. 2000-86656), and “Liquid crystals”, 1999, Vol. 26, No. 10, 1425-1428).

[symbol]

[In the reaction scheme (1), R¹ is synonymous with that in the above formula (1). A¹ and B¹ represent O or S independently. R represents an alkyl group. X′ and X″ each represent a halogen atom.]

A compound for which A^{l} and B¹ in the above formula (15) are CH₂ can be manufactured according to the reaction scheme (2) below. That is, a 4-substituted phenol (23) is first reacted with hydrogen in the presence of a catalytic reduction catalyst, such as Raney nickel or Raney cobalt to synthesize a 4-substituted cyclohexanol (24) (see Japanese Unexamined Patent Application Publication No. Sho58-164676, Japanese Unexamined Patent Application Publication No. Hei2-131405), and U.S. Pat. No. 3,322,619, for instance). Then the thus obtained 4-substituted cyclohexanol (24) is reacted with pyridine-4-aldehide (22) to obtain the compound (15).

[symbol]

[In the reaction scheme (2), R¹ is synonymous with that in the above formula (1).]

Also, a compound for which X¹ in the above formula (16) is SO₂ or CO, which is the other of the starting materials in the above formula (16), may be selected from commercially available products. Also, a compound for which X¹ in the above formula (16) is P(O) (OH) can be obtained through the compound (26) represented by the formula (26) below and the compound represented by the formula (27) below from the compound represented by the formula (25) below according a reaction scheme (3) below (see “Journal of the American Chemical Society”, Vol. 87, No. 2, pp. 253-260, 1965, for instance).

[symbol]

[In the reaction scheme (3), n is synonymous with that in the above formula (1).]

### Synthesis of Second Pyridinium Salt Type Liquid Crystal Compound

The second pyridinium salt type liquid crystal compound represented by the above formula (2) may be synthesized according to the reaction formula (28) below, for example. That is, a compound (29) is first obtained by following a similar procedure to the above reaction scheme (1). Then the thus obtained compound (29) and a halide (30) are reacted with each other to obtain the second pyridinium salt type liquid crystal compound (see Japanese Unexamined Patent Application Publication No. Hei10-53585, Japanese Unexamined Patent Application Publication No. 2000-86723, Japanese Unexamined Patent Application Publication No. 2000-86656, and “Liquid Crystals”, 1999, Vol. 26, No. 10, pp. 1425-1428, for instance).

[symbol]

[R², R³, A², B², and Y in the reaction formula (28) are synonymous with those in the above formula (2).]

The lubricant-layer-forming composition may be prepared as follows. That is, the first pyridinium salt type liquid crystal compound and/or the second pyridinium salt type liquid crystal compound as obtained above and, if necessary, non-ionic liquid crystal compound and a non-ionic lubricant are/is added to a solvent such as alcohol and mixed together so as to prepare the lubricant-layer-forming composition. The solvent is not limited to any particular one as long as the rod-like ionic liquid crystal compound and the like can be dissolved with it. The content of the rod-like ionic liquid crystal compound in the lubricant-layer-forming composition may be 0.001 wt % to 10 wt % of the total amount of the lubricant-layer-forming composition, for instance.

### Method for Forming Lubricant Layers

The lubricant layers 18 may be provided on the base material 11 of the magnetic disk 10 as follows. That is, a lubricant-layer-forming composition that contains a rod-like ionic liquid crystal compound having a cation group and an anion group is first adhered to the base material 11 of the magnetic disk 10. In the present embodiment, the lubricant-layer-forming composition is adhered to a main surface of the protective layer 16 formed over the base material 11. A method employed for depositing or applying the lubricant-layer-forming composition to the base material may be a dip method, a spraying method, a spin coating method, a cast method, a vacuum evaporation method, or the like, for instance. Then the lubricant-layer-forming composition adhered to the base material is heated. Though this heating process, the solvent in the lubricant-layer-forming composition is vaporized and the rod-like ionic liquid crystal compound is formed into a regularly vertical sequence. The heating temperature may be 50 to 150° C., for instance, and the heating time may be 1 to 60 minutes, for instance. As an example, the lubricant-layer-forming composition applied to the base material is heated at 80° C. for 10 minutes.

After the lubricant-layer-forming composition has been applied to the base material 11, a process in which the surface of coated film of the lubricant-layer-forming composition is leveled off to achieve a uniform thickness of the coated surface thereof may be carried out before the heating process. This allows the layer thickness of the lubricant layer 18 to be uniform. As a result, the variation in the distance between the lubricant layer 18 and the head 22 can be suppressed and the fluid resistance of the lubricant layer 18 relative to the head 22 can be made uniform. Also, the lubricant layer 18 is preferably formed of a substance whose surface energy is low. This can suppress the other materials from being adsorbed onto the magnetic disk 10.

An operation of the disk drive device 1 equipped with the magnetic disk 10 configured as described above will now be described. As the drive current is supplied to the brushless motor by which to drive the hub 4, the hub 4 and the magnetic disk 10 rotate. At the same time, the voice coil motor 28 has the swing arm 24 swing and thereby the head 22 moves back and forth within a swingable range. In the disk drive device 1 according to the present embodiment, the head 22 is present on the surface of the magnetic disk both when the magnetic disk 10 is rotating and while the magnetic disk 10 is at rest. In other words, the disk drive device 1 operates such that the rotation of the magnetic disk 10 starts and stops with the head in direct contact with the surface of the magnetic disk 10; that is, a so-called head contact start/stop method is employed in the disk drive device 1.

While the rotating speed of the magnetic disk 10 is slow, the head 22 slides or slips on the outermost surface, namely the lubricant layer 18, of the magnetic disk 10. As the rotating speed of the magnetic disk 10 gets higher, a lift force is caused by a flow of air near the surface of the magnetic disk 10 with the result that the head 22 is lifted very slightly above the surface of the lubricant layer 18. In the disk drive device 1 according to the present embodiment, the head lift at the time when data recorded on the magnetic disk 10 is to be read is set to 10 nm or below. Thus the data can be stably written and read even though the recording density of the magnetic disk 10 is raised. The head 22 converts magnetic data recorded on the magnetic disk 10 into electric signals and then transmits the electric signals to a control board (not shown). Also, the electric signals sent from the control board are written to the magnetic disk as magnetic data.

Note that the disk drive device 1 may employ a structure in which the data is written to and read from the magnetic disk 10 with the head 22 placed in contact with at least the lubricant layer 18 (i.e., a contact recording method). Thus the data can be stably written and read even though the recording density of the magnetic disk 10 is raised. In other words, the occurrence of so-called read-write error can be suppressed.

As described above, the magnetic disk 10 according to the present embodiment is configured such that the lubricant layer 18 formed on or over the base material 11 contains the rod-like ionic liquid crystal compound having a cation group and an anion group. Thus, the rod-like ionic liquid crystal compound forms a uniformly vertical sequence within the lubricant layer 18. And formed is a film of the rod-like ionic liquid crystal compound firmly bound in an ionic bond with the surface of the underlying layer. Thereby, the lubricant layer 18 is least likely to be pealed from the surface of the magnetic disk 10, and the normal operation of recording and reading the data can be ensured even when the head lift is made smaller. Hence, larger capacities for the disk drive device 1 can be realized while assuring its operation reliability. Even though the disk drive device 1 is dropped by accident, for instance, to give shocks to the disk drive device 1, the lubricant layer 18 according to the present embodiment is much less likely to be pealed from the magnetic disk 10 as compared with a conventional lubricant layer that does not contain the rod-like ionic liquid crystal compound. Hence, the shock resistance of the disk drive device 1 can be enhanced.

The present invention is not limited to the above-described embodiments only, and it is understood by those skilled in the art that changes in design may be added to the embodiments based on their knowledge and the embodiments added with such modifications are also within the scope of the present invention. New embodiments arising from the added modifications and a combination thereamong also enjoy the advantageous effects of their respective embodiments combined.

Though, in the above-described embodiments, the disk drive device 1 uses the head contact start/stop method, this should not be considered as limiting and, for example, a load/unload method may be used instead. Here, the load/unload method is such that the head 22 is present on the surface of the magnetic disk 10 only when the magnetic disk 10 is rotating, and the head 22 is lifted off the surface of the magnetic disk 10 into a safe location while the magnetic disk 10 is at rest. This load/unload technique can reduce the risk of stiction that may occur between the magnetic disk 10 and the head 22.

A description is now given of an exemplary embodiment, which is a mere example to explain the present invention and does not limit the present invention in any way.

### Exemplary Embodiment

As the rod-like ionic liquid crystal compound, a 5 mg of the second pyridinium salt type liquid crystal compound, of which A² and B² are O, R³ is C₂H₅, R² is C₁₀H₂₁, and Y is Br in the above formula (2), was added to a 1 ml of ethanol and then dissolved so as to prepare a lubricant-layer-forming composition according to an exemplary embodiment. The thus obtained lubricant-layer-forming composition was spin-coated on a stainless plate (SUS 304 plate), which serves as a test specimen, by use of a spin coater. Then the test specimen is placed and held on a hot plate and is heated at 80° C. for 30 minutes.

The test specimen coated with the lubricant-layer-forming composition according to the exemplary embodiment was placed and held on a surface nature measuring instrument (TYPE 14FW, manufactured by SHINTO scientific Co., Ltd.). And a stainless-steel ball (SUS 304 ball) whose diameter is 10 mm was slid back and forth on the surface of the test specimen. The above surface nature test was conducted under the following conditions. The vertical load: 100 g, the friction speed: 600 mm/minute, the number of times in moving back and forth: 1800 times, the reciprocating stroke: 5 mm, the load converter capacity: 19.61 N, and the test specimen temperature: 40° C. Then whether or not any damage has been caused on the surface of the test specimen was observed and verified visually.

### Comparative Example

A composition for use in a comparative example is prepared using the same procedure and the condition as the exemplary embodiment excepting that the rod-like ionic liquid crystal compound was not added. And the thus obtained composition for the comparative example was coated on a test specimen and then a surface nature test was conducted to verify if there is any damage on the surface of the test specimen.

As a result, although no damage was found in the exemplary embodiment, damages were found on the surface of the test specimen in the comparative example. Therefore, it was verified that the inclusion of the rod-like ionic liquid crystal compound in the lubricant-layer-forming composition achieves the formation of a lubricant layer whose protection property is excellent.

The features and characteristics of the present invention described based on the above-described embodiments may be defined by the following Item 1 to Item 10:

(Item 1) A magnetic disk including:
a base material; and
a lubricant layer provided on or over a base material, the lubricant layer containing a rod-like ionic liquid crystal compound having a cation group and an anion group.
   (Item 2) A magnetic disk according to Item 1, wherein the cation group is a pyridinium group.
   (Item 3) A magnetic disk according to Item 1 or Item 2, wherein the rod-like ionic liquid crystal compound contains at least one of a first pyridinium salt type liquid crystal compound represented by a formula (1) and a second pyridinium salt type liquid crystal compound represented by a formula (2).

[symbol]

[In a formulas (1), R¹ is an alkyl group, an alkoxy group, or a group having an unsaturated bond represented by the following formula (3). A¹ and B² are each independently O, S, NH or CH₂. X⁻ is SO₃⁻, COO⁻, PO₃⁻, or PO₃²⁻. “n” is an integer greater than or equal to “0”.]

[symbol]

[In a formulas (2), R² and R³ are each independently an alkyl group, an alkoxy group, or a group having an unsaturated bond represented by the following formula (3). A² and B² are each independently O, S, NH or CH₂. Y⁻ is a halogen atom.]

[symbol]

[In the formulas (3), R⁴ is H or CH₃, and Z is (CH₂)ₘ, (CH₂)ₘ—O, CO—O—(CH₂)ₘ, CO—O—(CH₂)ₘ—O, C₆H₄—CH₂—O, or CO. “m” is any one of integers 1 to 30.]
(Item 4) A magnetic disk according to Item 3, wherein the lubricant layer contains a plurality of kinds of rod-like ionic liquid crystal compounds.
(Item 5) A magnetic disk according to any one of Item 1 to Item 4, wherein the rod-like ionic liquid crystal compound forms a vertical sequence in relation to a surface of an underlying layer.
(Item 6) A magnetic disk according to any one of Item 1 to Item 5, wherein the lubricant layer has a monomolecular layer of the rod-like ionic liquid crystal compound in at least a part of a region where the lubricant layer is in contact with an underlying layer.
(Item 7) A magnetic disk according to any one of Item 1 to Item 6, wherein the lubricant layer contains at least one of a non-ionic liquid crystal compound and a non-ionic lubricant.
(Item 8) A magnetic disk according to any one of Item 1 to Item 7, further including:
an ground layer provided in a surface of the base material;
a magnetic layer provided in a surface of the ground layer; and
a protective layer provided in a surface of the magnetic layer,
wherein the lubricant layer is provided in a surface of the protective layer.
   (Item 9) A lubricant-layer-forming composition for forming a lubricant layer provided on a base material of a magnetic disk, wherein the lubricant-layer-forming composition contains a rod-like ionic liquid crystal compound having a cation group and an anion group.
   (Item 10) A method for forming a lubricant layer, including:
applying the lubricant-layer-forming composition according to Item 9 to the base material of the magnetic disk; and
heating the lubricant-layer-forming composition applied to the base material.

What is claimed is:

1. A magnetic disk comprising:
a base material; and
a lubricant layer provided on or over a base material, the lubricant layer containing a rod-like ionic liquid crystal compound having a cation group and an anion group.

2. A magnetic disk according to claim 1, wherein the cation group is a pyridinium group.

3. A magnetic disk according to claim 1, wherein the rod-like ionic liquid crystal compound contains at least one of a first pyridinium salt type liquid crystal compound represented by a formula (1) and a second pyridinium salt type liquid crystal compound represented by a formula (2).
z,999
[In a formulas (1), R¹ is an alkyl group, an alkoxy group, or a group having an unsaturated bond represented by the following formula (3). A¹ and B¹ are each independently O, S, NH or CH₂. X⁻ is SO₃⁻, COO⁻, PO₃⁻, or PO₃²⁻. “n” is an integer greater than or equal to “0”.] [symbol]
[In a formulas (2), R² and R³ are each independently an alkyl group, an alkoxy group, or a group having an unsaturated bond represented by the following formula (3). A² and B² are each independently O, S, NH or CH₂. Y⁻ is a halogen atom.] [symbol]
[In the formulas (3), R⁴ is H or CH₃, and Z is (CH₂)_{m,} (CH₂)ₘ—O, CO—O—(CH₂)ₘ, CO—O—(CH₂)ₘ—O, C₆H₄—CH₂—O, or CO. “m” is any one of integers 1 to 30.]

4. A magnetic disk according to claim 3, wherein the lubricant layer contains a plurality of kinds of rod-like ionic liquid crystal compounds.

5. A magnetic disk according to claim 1, wherein the rod-like ionic liquid crystal compound forms a vertical sequence in relation to a surface of an underlying layer.

6. A magnetic disk according to claim 1, wherein the lubricant layer has a monomolecular layer of the rod-like ionic liquid crystal compound in at least a part of a region where the lubricant layer is in contact with an underlying layer.

7. A magnetic disk according to claim 1, wherein the lubricant layer contains at least one of a non-ionic liquid crystal compound and a non-ionic lubricant.

8. A magnetic disk according to claim 1, further comprising:
an ground layer provided in a surface of the base material;
a magnetic layer provided in a surface of the ground layer; and
a protective layer provided in a surface of the magnetic layer,
wherein the lubricant layer is provided in a surface of the protective layer.

9. A lubricant-layer-forming composition for forming a lubricant layer provided on a base material of a magnetic disk, wherein the lubricant-layer-forming composition contains a rod-like ionic liquid crystal compound having a cation group and an anion group.

10. A method for forming a lubricant layer, comprising:
applying the lubricant-layer-forming composition according to claim 9 to the base material of the magnetic disk; and
heating the lubricant-layer-forming composition applied to the base material.
